(19) United States
(12) Patent Application Publication
(10) Pub. No.: US 2022/0305965 A1
(43) Pub. Date: Sep. 29, 2022

(54) MOTOR VEHICLE SEAT

(71) Applicant: Faurecia Autositze GmbH, Hannover (DE)

(72) Inventors: Michael Lücke, Hannover (DE); Jenny Schmitz, Hessisch Oldendorf (DE); Oriana Gramatyka, Warsaw (PL); Marcin Piotrowski, Lesznowola (PL); Dariusz Stasik, Nowe Brusno (PL)

(21) Appl. No.: 17/702,144

(22) Filed: Mar. 23, 2022

(30) Foreign Application Priority Data
Mar. 29, 2021 (DE) 10 2021 107 896.2

(51) Int. Cl. B60N 2/16; B60N 2/02; B60N 2/10

(52) U.S. Cl. CPC B60N 2/166; B60N 2/0232; B60N 2/10

(57) ABSTRACT

A motor vehicle seat with a seat inclination adjustment device, with a first base element, a first seat frame element and a first actuator element, the actuator element has a lower link arm connected to the base element and arranged movably relative to the base element, an upper link arm connected to the lower link arm and movably arranged relative to the lower link arm, the upper link arm is connected to the seat frame element and is movably arranged, and a linear actuator with first and second linear actuator elements, the first linear actuator element is movably connected to the second linear actuator element and the first linear actuator element is movably connected to the base element and the second linear actuator element is movably connected to one of the link arms.

### CROSS-REFERENCE TO RELATED APPLICATION

This application claims priority to German Patent Application No. 10 2021 107 896.2, filed on Mar. 29, 2021, the content of which is incorporated herein by reference.

### BACKGROUND

Motor vehicle seats often have an inclination adjustment for the seat cushion, with which a user can adjust the angle of inclination of the seat cushion. To do this, the front of the seat cushion is raised or lowered. This inclination adjustment can also be coupled with a seat height adjustment, with the front and back of the seat cushion being able to be adjusted in height.

Motor vehicle seats that are used, for example, in vehicles for passenger transport (such as buses, trains, etc.) often have a belt system that is integrated into the motor vehicle seat. Such a motor vehicle seat is exposed to strong forces in the front area of the inclination adjustment, particularly in the event of a frontal collision. In addition, a large adjustment range of the angle of inclination is desirable in order to enable the occupant to sit in a relaxed position. Last but not least, such motor vehicle seats have a small width, so the inclination adjustment must have compact dimensions.

EP 2617601 A1 discloses a height adjustment of the seat cushion, in which the front and rear link arms of the seat frame are moved by rotating gears. The gears mesh with toothed racks that are arranged on the link arms. This causes the front and rear of the seat frame to be raised and lowered. This adjustment of the seat cushion has the disadvantage that the racks and gears must be very large in order to compensate for the forces to be expected in the event of a collision. The adjustment range is also limited.

JP 4958471 B2 discloses a height adjustment of the seat cushion in that the front and rear areas of the seat frame are adjusted by a respective motor. Each motor has a spindle shaft that drives a worm screw at the front and rear of the seat frame, respectively. The worm screws are arranged diagonally on opposite longitudinal sides of the seat frame.

Utility model CN 2018 56665 U discloses a motorized inclination adjustment of the seat cushion, in which the motor drives a spindle shaft. The shaft drives a worm gear on a longitudinal side of the seat frame and thus adjusts its angle of inclination.

KR 101776515 B1 also discloses a motorized inclination adjustment that only drives one side of the seat cushion. The motor is arranged in a fixed position and is not raised or lowered during the adjustment process.

These three seat inclination adjustments have the disadvantage that they are only arranged on one longitudinal side of the motor vehicle seat in the front area of the seat cushion. The opposite longitudinal side is therefore not designed to compensate for the strong forces in case of collision.

### SUMMARY

It is therefore the object of the present invention to provide a motor vehicle seat with a seat inclination adjustment which can compensate for the strong forces occurring in particular during a frontal collision, and thus reduce the risk of injury to an occupant. It is also an object of the present invention to provide a motor vehicle seat with a seat inclination adjustment which has a large adjustment range, requires little space and can be produced inexpensively. It is also an object of the present invention to provide a method for adjusting the seat inclination of a motor vehicle seat, with which the occurring strong forces are compensated, particularly during a frontal collision, which provides a large adjustment range of the seat cushion and which requires little space.

The object is achieved by means of the motor vehicle seat according to claim 1. Advantageous embodiments of the invention are set out in the dependent claims.

The motor vehicle seat with a seat inclination adjustment device according to the invention has a base element and a seat frame element. The base element is arranged on the longitudinal adjustment of the motor vehicle seat, the seat frame element is arranged on the seat frame that accommodates the seat cushion. The motor vehicle seat according to the invention also has a first actuator element. The first actuator element has a lower link arm which is connected to the base element via a lower link and is arranged such that it can move relative to the base element. Furthermore, the first actuator element has an upper link arm, which is connected to the lower link arm via a middle link and is arranged movably relative to the lower link arm. The first actuator element additionally has a linear actuator with a first linear actuator element and a second linear actuator element, the first linear actuator element being movably connected to the second linear actuator element via a linear movement. According to the invention, the first linear actuator element is movably connected to the base element via a first linear actuator link and/or the second linear actuator element is movably connected to one of the link arms via a second linear actuator link. When the two linear actuator elements perform a linear movement relative to one another, the lower and upper link arms are pivoted relative to one another in such a way that the angle between the lower and upper link arms changes and the seat frame element is thus raised or lowered.

In a development of the invention, one of the two linear actuator elements is connected to the lower link arm. When the two linear actuator elements perform a linear movement relative to one another, a force is exerted on the lower link arm, as a result of which the lower link arm is pivoted relative to the base element.

In an alternative embodiment of the invention, the first and/or the second linear actuator element is fastened to the lower or the upper link arm. Optionally, the first linear actuator element is fastened to the upper link arm and the second linear actuator element is fastened to the lower link arm, or the first linear actuator element is fastened to the lower link arm and the second linear actuator element is fastened to the upper link arm. In an alternative embodiment of the invention, the linear actuator elements are fastened via the respective linear actuator links. This is advantageous because in the event of a crash, the linear actuator stabilizes the link between the lower link arm and the upper link arm.

In a further embodiment of the invention, the seat inclination adjustment device has a second actuator element. The second actuator element is arranged on the longitudinal side of the motor vehicle seat which is opposite the longitudinal side of the motor vehicle seat on which the first actuator element is arranged. The first and second actuator elements are therefore arranged on opposite longitudinal sides of the motor vehicle seat, preferably in the front area of the motor vehicle seat. The strong forces acting on the motor vehicle seat during a frontal collision are thus advantageously distributed over two actuator elements.

In a further embodiment of the invention, the actuator element has a motor. The seat inclination can therefore be adjusted in a motorized way, which increases the comfort for a user.

In a further embodiment of the invention, the motor is coupled to two actuator elements. The motor drives the two actuator elements at the same speed.

In a development of the invention, the motor is coupled to two actuator elements via two shafts. The motor is positioned in such a way that it is arranged between the two actuator elements. The two shafts are located at respective opposite ends of the drive shaft of the motor and have the same length. The seat inclination adjustment device according to the invention can be easily and quickly adapted to different dimensions of a motor vehicle seat by flexible adjustment of the length of the shafts.

In a further embodiment of the invention, one of the shafts is a flexible shaft (flex shaft). Due to the flexible design of the shaft, preferably both shafts, changes in length during the adjustment process are compensated.

In a further embodiment of the invention, the base element is an adapter element. The adapter element is a standard component that can be produced in large quantities and is therefore inexpensive. The adapter element can have a clip or plug-in connection, for example, and is therefore quick and easy to assemble.

In a development of the invention, the base element is an adapter element that is connected to one or both upper rails of a longitudinal seat adjustment. The adapter element can have a clip or plug-in connection, for example, and can therefore be mounted quickly and easily on the upper rail of the longitudinal seat adjustment.

In a further embodiment of the invention, the linear actuator element is a spindle with a spindle worm. Spindles which are provided with a spindle worm convert the rotational movement of the motor into a translational movement. In addition, spindles with a spindle worm have a high resistance to translational forces, so that large forces occurring during a frontal collision are effectively compensated.

In a further embodiment of the invention, the spindle is fastened to the base element and/or the spindle worm is fastened to the link arm. As a result, a translational movement of the spindle is initiated when the spindle worm rotates. The spindle exerts a force on the link arm such that it is pivoted with respect to the base element.

The object is also achieved by the method for adjusting the seat inclination of a motor vehicle seat.

The method for adjusting the seat inclination of a motor vehicle seat takes place via a linear movement of a first linear actuator element relative to a second linear actuator element. Both linear actuator elements are components of a linear actuator of the motor vehicle seat. The motor vehicle seat also has a base element and a seat frame element. The motor vehicle seat according to the invention also has a first actuator element. The first actuator element has a lower link arm which is connected to the base element via a lower link and is arranged such that it can move relative to the base element. Furthermore, the first actuator element has an upper link arm which is connected to the lower link arm via a middle link and is arranged such that it can move relative to the lower link arm. According to the invention, the first linear actuator element is movably connected to the base element via a first linear actuator link and/or the second linear actuator element is movably connected to one of the link arms via a second linear actuator link. When the two linear actuator elements perform a linear movement relative to one another, the lower and upper link arms are pivoted relative to one another in such a way that the angle between the lower and upper link arms changes and the seat frame element is thus raised or lowered.

In a further embodiment of the invention, the second linear actuator element is movably connected to the lower link arm via a second linear actuator link. When the two linear actuator elements perform a linear movement relative to one another, a force is exerted on the lower link arm, as a result of which the lower link arm is pivoted relative to the base element.

In an alternative embodiment of the invention, the first and/or the second linear actuator element are fastened to the lower or the upper link arm. Optionally, the first linear actuator element is fastened to the upper link arm and the second linear actuator element is fastened to the lower link arm, or the first linear actuator element is fastened to the lower link arm and the second linear actuator element is fastened to the upper link arm. In an alternative embodiment of the invention, the linear actuator elements are fastened via the respective linear actuator links. When the linear actuator is actuated, a force is thus transmitted from a link and/or onto a link arm. This is advantageous because in the event of a crash, the linear actuator stabilizes the link between the lower link arm and the upper link arm.

In a development of the invention, the linear actuator element is a spindle with a spindle worm. Spindles with a spindle worm convert the rotational movement of the motor into a translational movement. In addition, spindles with a spindle worm have a high resistance to translational forces, so that large forces occurring during a frontal collision are effectively compensated.

In a further embodiment of the invention, the spindle is fastened to the base element and/or the spindle worm is fastened to the link arm. As a result, a translational movement of the spindle is initiated when the spindle worm rotates. The spindle exerts a force on the link arm such that it is pivoted with respect to the base element.

Exemplary embodiments of the motor vehicle seat according to the invention with the seat inclination adjustment device also according to the invention and the method according to the invention for adjusting the seat inclination are shown in a schematically simplified manner in the drawings and are explained in more detail in the following description.

The invention relates to a motor vehicle seat with a seat inclination adjustment device, with a first base element, a first seat frame element and a first actuator element, wherein the actuator element has a lower link arm connected to the base element via a lower link and arranged movably relative to the base element, an upper link arm connected to the lower link arm via a middle link and movably arranged relative to the lower link arm, wherein the upper link arm is connected to the seat frame element via an upper link and is movably arranged, and a linear actuator with a first and a second linear actuator element, the first linear actuator element being movably connected via a linear movement to the second linear actuator element.

### BRIEF DESCRIPTION OF THE DRAWINGS

FIG. 1a: is a perspective view of the seat inclination adjustment device according to the invention with the seat inclination in the minimum position

FIG. 1b: is a plan view of the seat inclination adjustment device according to the invention with the seat inclination in the minimum position

FIG. 1c: is a side view of the seat inclination adjustment device according to the invention with the seat inclination in the minimum position

FIG. 2a: is a perspective view of the seat inclination adjustment device according to the invention with the seat inclination in the maximum position

FIG. 2b: is a side view of the seat inclination adjustment device according to the invention with the seat inclination in the maximum position

FIG. 3: is an exploded view of the seat inclination adjustment device according to the invention

FIG. 4: is a perspective view of the seat inclination adjustment device according to the invention

### DETAILED DESCRIPTION OF ILLUSTRATIVE EMBODIMENTS

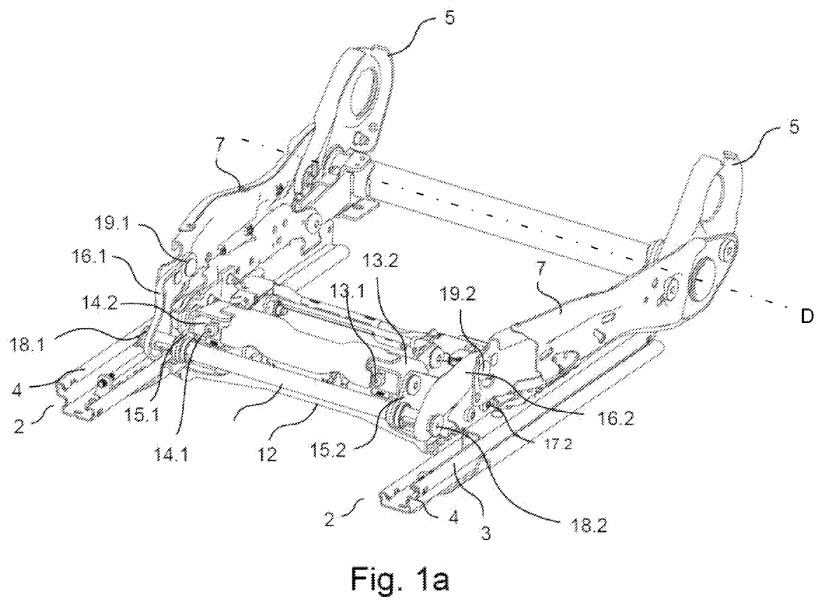

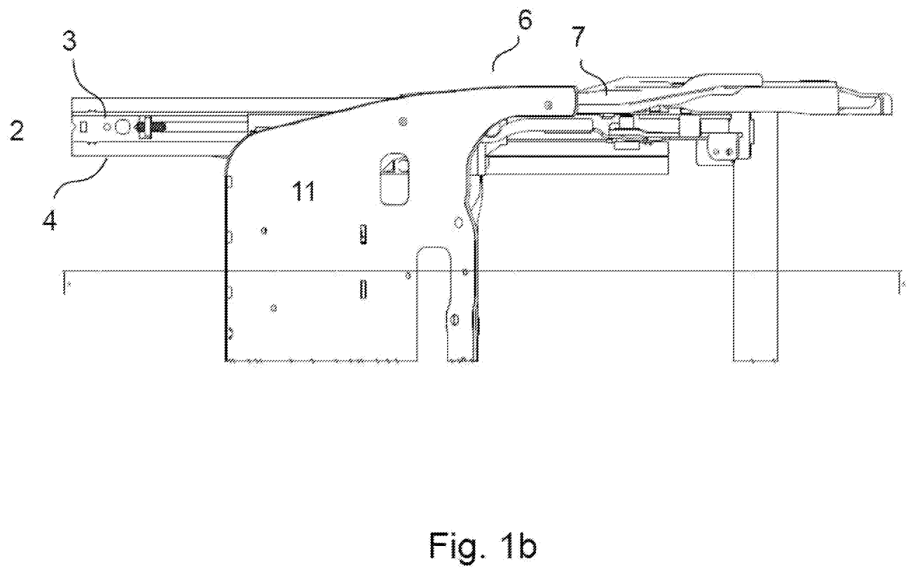

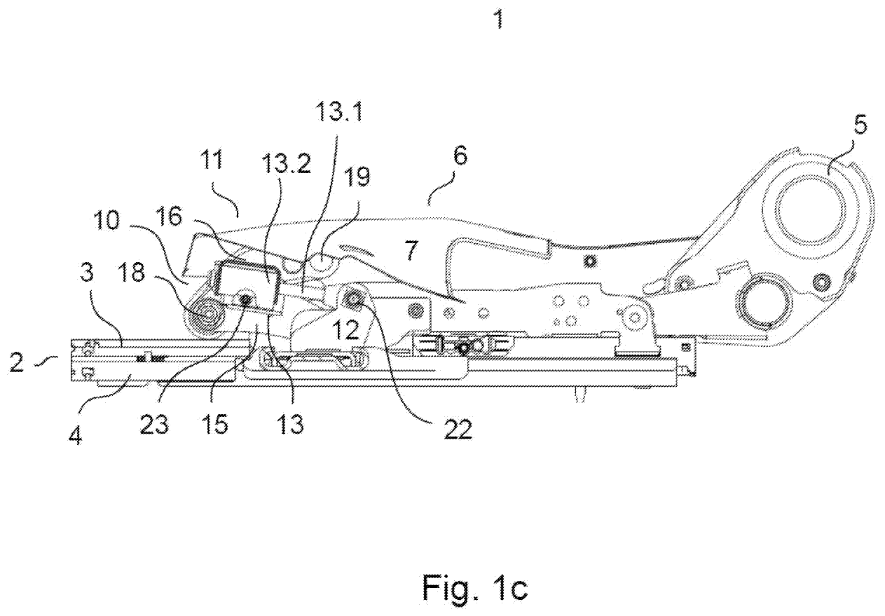

FIG. 1 shows an exemplary embodiment of the seat inclination adjustment device 10 according to the invention, with the seat inclination being adjusted in the minimum position. The motor vehicle seat 1 has a seat frame 7 for a seat cushion 6 and a backrest 5 which is pivotally mounted on the seat frame 7. The longitudinal seat adjustment 2 has an upper rail 3 and a lower rail 4 (FIG. 1b). The motor vehicle seat 1 is firmly connected to the upper rail 3, which in turn is guided in the lower rail 4 so that it can be adjusted in the longitudinal direction. To adjust the inclination of the seat frame 7 about the axis of rotation D, the motor vehicle seat 1 has the seat inclination adjustment device 10. The seat inclination adjustment device 10 is arranged on the front side of the motor vehicle seat 1 (FIG. 1a).

The seat inclination adjustment device 10 has the base element 12 which is fixedly arranged on the upper rail 3. The base element 12 is preferably an adapter element which is connected to the upper rail 3 of the longitudinal seat adjustment 2 simply and quickly, for example by means of a clip or plug-in connection. The base element 12 is connected to the lower link arm 15.1, 15.2 via the lower link 17.1, 17.2. The lower link arm 15.1, 15.2 is pivotally connected to the upper link arm 16.1, 16.2 by the middle link 18.1, 18.2 (FIG. 1c). The upper link arm 16.1, 16.2 is pivotally connected to the seat frame element 11 by the upper link 19.1, 19.2.

In the minimum position of the seat inclination adjustment device 10 shown in this figure, the lower link arm 15.1, 15.2 is aligned almost horizontally, the lower link arm 15.1, 15.2 and the upper link arm 16.1, 16.2 having an angle of less than 90° to one another. The seat inclination adjustment device 10 is driven via a motor 30. The adjustment motor 30 is an electric motor which drives the actuator elements 13, 14 of the linear actuator 24 via two flex shafts 13.3, 14.3 which are arranged on opposite end faces of the motor 30 on its drive shaft. The electric motor 30 is arranged in the middle between the actuator elements 13, 14 and is reversible, this meaning that the direction of rotation of the electric motor 30 can be reversed in order to drive the adjustment of the seat frame 7 in two directions (upwards, downwards) by generating a force. The actuator elements 13, 14 themselves are arranged as mirror images on opposite longitudinal sides of the motor vehicle seat 1 (FIG. 1a) and are constructed mirror-symmetrically to one another.

The first actuator element 13 (FIG. 1c) has a first linear actuator element 13.1 and a second linear actuator element 13.2 and is designed as a spindle 13.1 with a spindle worm 13.2. The spindle 13.1 is rotatably fastened to the base element 12 via the 1st linear actuator link 22, the spindle worm 13.2 being rotatably fastened to the lower link arm 15.1 via the 2nd linear actuator link 23 of the actuator element 13. The same applies to the second actuator element 14, only in a mirror inverted way.

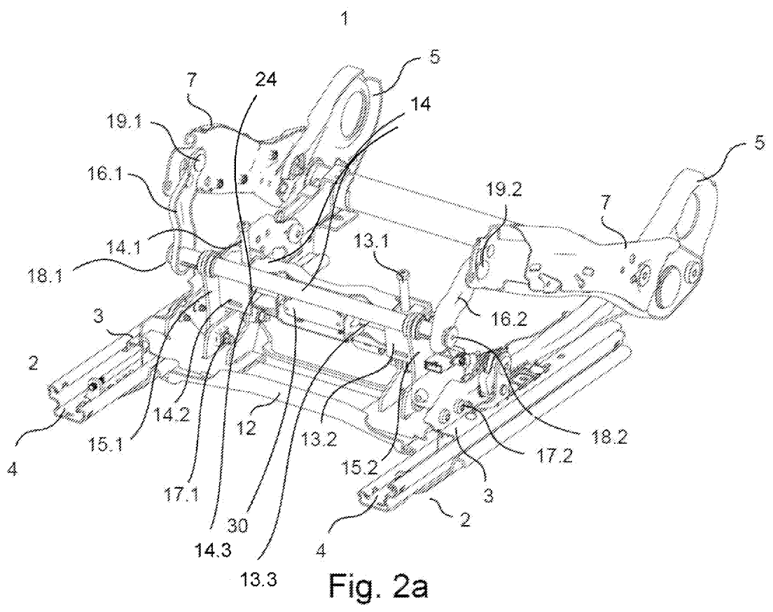

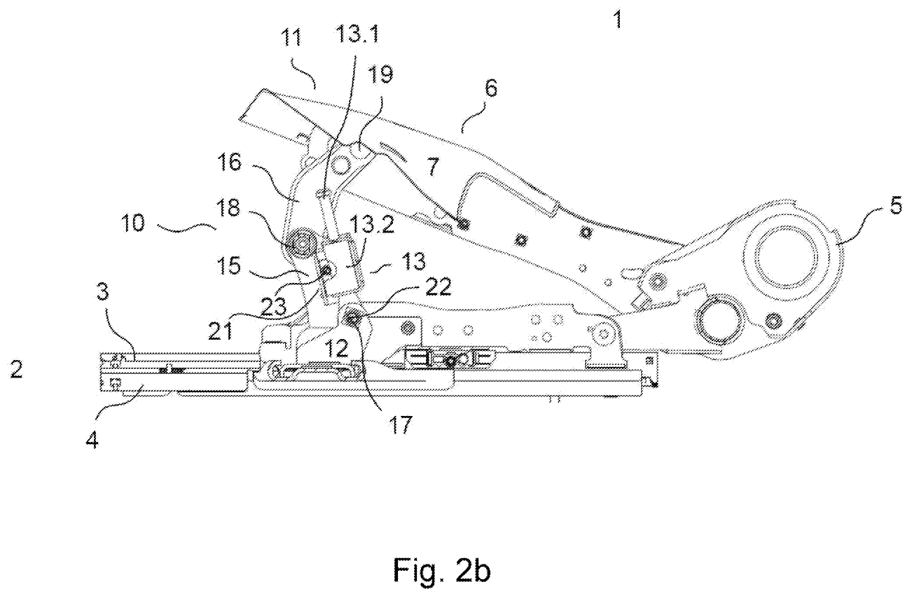

To adjust the seat inclination, the motor 30 is put into operation, driving the spindle worm 13.2, 14.2 of both actuator elements 13, 14 at the same speed via the flex shafts 13.3, 14.3. The spindle worm 13.2, 14.2 also drives the spindles 13.1, 14.1 at the same speed. The spindles 13.1, 14.1 thus perform a linear movement, with the spindles 13.1, 14.1 pivoting the lower link arm 15.1, 15.2 (see FIG. 2). The actuator elements 13, 14 are guided closer to the base elements 12 by the linear movement of the spindles 13.1, 14.1, the lower link arm 15.1, 15.2 pivots the upper link arm 16.1, 16.2, which is pivotally connected to the lower link arm 15.1, 15.2 through the middle link 18.1, 18.2. The angle between the lower link arm 15.1, 15.2 and the upper link arm 16.1, 16.2 is increased, the seat frame 7 pivots about the axis of rotation D.

An exemplary embodiment of the seat inclination adjustment device 10 according to the invention, in which the seat inclination is adjusted in the maximum position, is shown in FIG. 2. The seat inclination adjustment device 10 is the same described in the previous figure (see FIG. 1). The actuator elements 13, 14 (FIG. 2a) which are arranged in a mirror-inverted way on the longitudinal sides of the motor vehicle seat 1 have the minimum possible distance to the base elements 12, the spindles 13.1, 14.1 are extended to the maximum (FIG. 2b). The lower link arm 15.1, 15.2 is aligned almost vertically, the lower link arm 15.1, 15.2 and the upper link arm 16.1, 16.2 have an angle greater than 90° to one another.

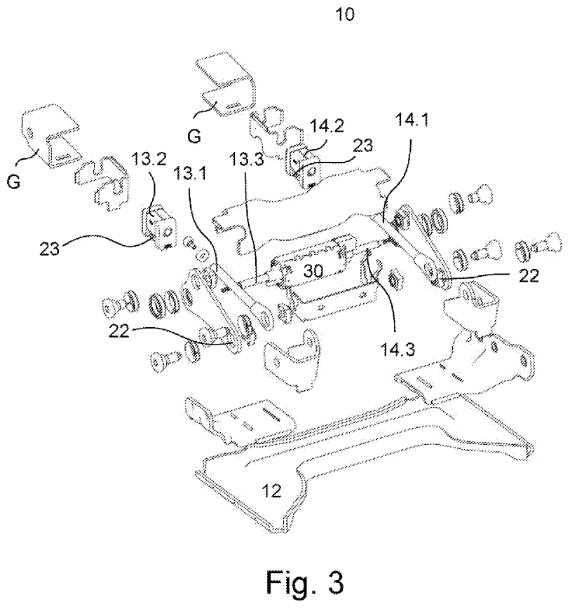

FIG. 3 shows an exploded view of an exemplary embodiment of the seat inclination adjustment device 10 according to the invention. The seat inclination adjustment device 10 is arranged on the front of the motor vehicle seat 1. The seat inclination adjustment device 10 has the base elements 12 which are fixedly arranged on the upper rails 3 of a seat adjustment device 2 (not shown). The base elements 12 are connected to the lower link arms 15.1, 15.2 via lower links 17.1, 17.2. The lower link arms 15.1, 15.2 are pivotally connected to the upper link arms 16.1, 16.2 by middle links 18.1, 18.2. The seat inclination adjustment device 10 is driven by a motor 30. The motor 30 has a cover G. The electric motor 30 is arranged in the middle between the actuator elements 13, 14. The adjusting motor 30 is an electric motor which drives the actuator elements 13, 14 via two flex shafts 13.3, 14.3 which are arranged on opposite end faces of the motor 30 on its drive shaft. The actuator elements 13, 14 themselves are arranged as mirror images on opposite longitudinal sides of the motor vehicle seat 1 and are constructed mirror-symmetrically to one another. The actuator elements 13, 14 each have a first linear actuator element (spindle) 13.1, 14.1 and a second linear actuator element (spindle worm) 13.2, 14.2. The spindles 13.1, 14.1 are rotatably fastened to the base elements 12 via a 1st linear actuator link 22, the spindle worms 13.2, 14.2 are rotatably fastened to the lower link arms 15.1, 15.2 via the 2nd linear actuator link 23 of an actuator element 13, 14.

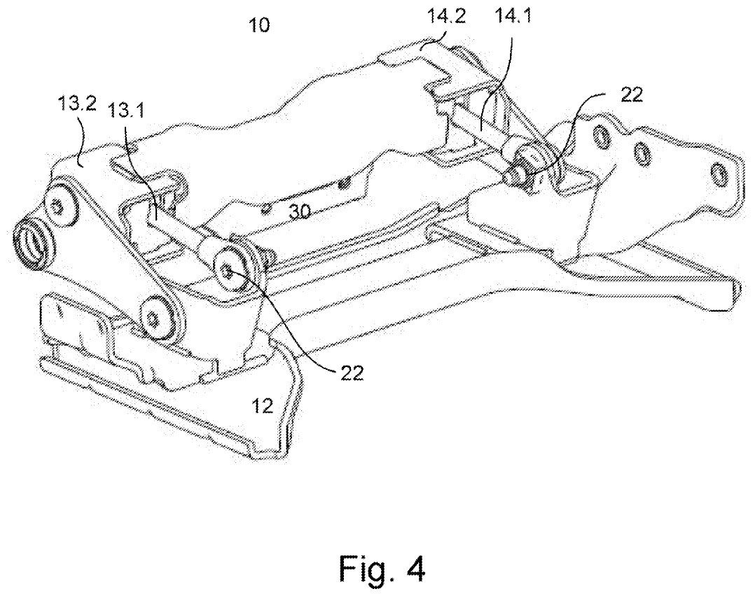

A perspective view of an embodiment of the seat inclination adjustment device 10 according to the invention is shown in FIG. 4. The seat inclination adjustment device 10 is the same shown in the previous figures (see FIGS. 1-3). The electric motor 30 is arranged in the middle between the actuator elements 13,14. To adjust the seat inclination, the motor 30 drives both actuator elements 13, 14 at the same speed via the flex shafts 13.3, 14.3. The combination of spindle worm 13.2, 14.2 with spindles 13.1, 14.1 enables the seat inclination adjustment device 10 according to the invention to withstand greater forces than previously known seat inclination adjustment devices, in particular during a frontal collision. In addition, due to the small dimensions of the seat inclination adjustment device 10 according to the invention, it is possible to mount the actuator elements 13, 14 symmetrically, which causes an even distribution of force on the longitudinal sides during an accident. At the same time, due to the small dimensions, the seat inclination adjustment device 10 according to the invention can be implemented in motor vehicle seats which are provided with an integrated belt system. The seat inclination adjustment device 10 is based on standardized drive elements which are tested and known.

### LIST OF REFERENCE NUMERALS

1 motor vehicle seat
2 longitudinal seat adjustment
3 upper rail
4 lower rail
5 backrest
6 seat cushion
7 seat frame
10 seat inclination adjustment device
11 seat frame element
12 base element
13 1st actuator element
13.1 1st linear actuator element of the 1st actuator element
13.2 2nd linear actuator element of the 1st actuator element
13.3 1st flex shaft of the 1st actuator element
14 2nd actuator element
14.1 1st linear actuator element of the 2nd actuator element
14.2 2nd linear actuator element of the 2nd actuator element
14.3 2nd flex shaft of the 2nd actuator element
15.1, 15.2 lower link arm
16.1, 16.2 upper link arm
17.1, 17.2 lower link
18.1, 18.2 middle link
19.1, 19.2 upper link
22 1st linear actuator link
23 2nd linear actuator link
24 linear actuator
30 motor
D axis of rotation

1. A motor vehicle seat with a seat inclination adjustment device, with
a base element,
a seat frame element, and
a first actuator element,
wherein the first actuator element
has a lower link arm which is connected to the base element via a lower link and is movably arranged relative to the base element,
has an upper link arm connected to the lower link arm via a middle link and arranged movably relative to the lower link arm,
wherein the upper link arm is connected to the seat frame element via an upper link and is movably arranged, and
has a linear actuator with a first linear actuator element and a second linear actuator element,
wherein the first linear actuator element is movably connected to the second linear actuator element via a linear movement,
characterized in that
the first linear actuator element is movably connected to the base element via a first linear actuator link and/or the second linear actuator element is movably connected to one of the link arms via a second linear actuator link.

2. The motor vehicle seat with a seat inclination adjustment device of claim 1
characterized in that
the second linear actuator element is connected to the lower link arm.

3. The motor vehicle seat with a seat inclination adjustment device of claim 1
characterized in that
the seat inclination adjustment device has a second actuator element.

4. The motor vehicle seat with a seat inclination adjustment device of claim 1
characterized in that
the actuator element has a motor,
wherein the motor is coupled to two actuator elements via two shafts,
wherein at least one of the shafts is a flex shaft.

5. The motor vehicle seat with a seat inclination adjustment device of claim 1
characterized in that
the base element is an adapter element which is connected to one or both upper rails of a longitudinal seat adjustment.

6. The motor vehicle seat with a seat inclination adjustment device of claim 1
characterized in that
the linear actuator element is a spindle with a spindle worm,
wherein the spindle is fastened to the base element and/or the spindle worm is fastened to the link arm.

7. A method for adjusting the seat inclination of a motor vehicle seat, with a base element,
a lower link arm which is connected to the base element via a lower link and is movably arranged relative to the base element,
an upper link arm connected to the lower link arm via a middle link and arranged movably relative to the lower link arm,
a seat frame element which is connected to the upper link arm via an upper link and is movably arranged with respect to the upper link arm,
a linear actuator with a first and a second linear actuator element,
wherein the seat inclination is adjusted via a linear movement of a first linear actuator element relative to a second linear actuator element
characterized in that
the first linear actuator element is movably connected to the base element via a first linear actuator link and/or the second linear actuator element is movably connected to one of the link arms via a second linear actuator link.

8. The method for adjusting the seat inclination of a motor vehicle seat of claim 7
characterized in that
the second linear actuator element is movably connected to the lower link arm via a second linear actuator link.

9. The method for adjusting the seat inclination of a motor vehicle seat of claim 7
characterized in that
the linear actuator element is a spindle with a spindle worm,

10. The method for adjusting the seat inclination of a motor vehicle seat of claim 9
characterized in that
the spindle is fastened to the base element and/or the spindle worm is fastened to the link arm.
